(19) United States
(12) Patent Application Publication
(10) Pub. No.: US 2014/0325366 A1
(43) Pub. Date: Oct. 30, 2014

(54) DATA INTEGRATION

(71) Applicant: BANK OF AMERICA CORPORATION, Charlotte, NC (US)

(72) Inventors: Jennifer Hardison DUNPHEY, Charlotte, NC (US); Connie Cabaniss HARRILL, Shelby, NC (US); Thomas J. MANJALLY, Edison, NJ (US); Sandeep SINGHVI, Charlotte, NC (US); Karin D. MARIANO, Huntersville, NC (US); Venkata Nagendra GUDIPATI, Charlotte, NC (US)

(73) Assignee: Bank of America Corporation, Charlotte, NC (US)

(21) Appl. No.: 13/870,204

(22) Filed: Apr. 25, 2013

(51) Int. Cl. G06F 3/0484

(52) U.S. Cl. CPC G06F 3/0484
USPC 715/738

(57) ABSTRACT

Systems, methods and apparatuses of integrating data from a variety of sources are provided. In some examples, the data integration system may receive data from multiple systems and integrate it. The system may include one or more user interfaces that present the integrated data in a simplified manner and allow customization of the user interface and, in some examples, manipulation of the data. In some arrangements, the integrated data may be received from internal and external sources and may include both publicly available and non-publicly available information.

### BACKGROUND

In today's on-the-go work environment, it can be difficult to access all information and data needed to perform one's job. For instance, many sales associates are often tasked with meeting clients, potential clients, and the like, which keeps them out of their offices for much of a typical workday. The use of mobile devices such as smartphones and tablet has helped these individuals remain connected to the office and has provided some accessibility to data. However, in complex entities, data is often stored in multiple different systems which may each require a separate login. This can be cumbersome and inefficient for people who benefit from accessing as much information as possible when working outside the office.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure relate to methods, computer-readable media, and apparatuses for integrating data in a data integration system. In some examples, data may be received from one or more sources. One or more of the sources may be internal to or associated with an entity implementing the system and/or one or more sources may be external to or not associated with the entity. In some examples, some data received may be publicly available information (such as news items, stock information, and the like), while other information may not be publicly available (e.g., it may be confidential client information entrusted to the entity). The data may be integrated and displayed on one or more user interfaces which are customizable.

In other examples, the data integration system may allow communication between multiple systems, applications, and the like. For instance, the integrated data system may communicate with an email application, calendar application, task list, and the like. Accordingly, data may be shared between these systems via the data integration system.

### BRIEF DESCRIPTION OF THE DRAWINGS

The present disclosure is illustrated by way of example and not limited in the accompanying figures in which like reference numerals indicate similar elements and in which:

FIG. 1 illustrates an example operating environment in which various aspects of the disclosure may be implemented.

FIG. 2 illustrates an example data integration system according to one or more aspects described herein.

FIG. 3 is an example method of integrating data and accessing the integrated data according to one or more aspects described herein.

FIG. 4 is one example user interface for accessing data in the data integration system according to one or more aspects described herein.

FIGS. 5A-5C illustrate another example user interface for accessing data in the data integration system according to one or more aspects described herein.

FIG. 6 is yet another example user interface for accessing data in the data integration system according to one or more aspects described herein.

FIG. 7 illustrates another arrangement of a user interface for accessing data in the data integration system according to one or more aspects described herein.

FIGS. 8A and 8B illustrates additional interfaces providing additional details about an item of information and overlaying at least a portion of a first user interface according to one or more aspects described herein.

FIG. 9 is an example email illustrating the communication and data sharing between multiple systems and applications according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized, and that structural and functional modifications may be made, without departing from the scope of the present claimed subject matter.

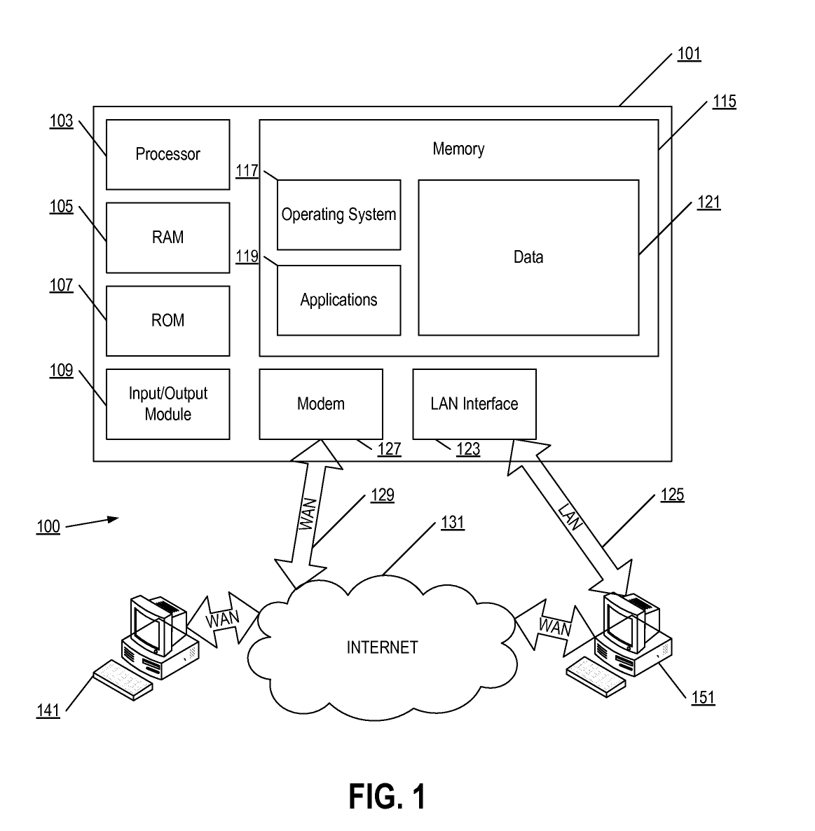

FIG. 1 illustrates an example block diagram of a generic computing device 101 (e.g., a computer server) in an example computing environment 100 that may be used in one or more illustrative embodiments of the disclosure. For example, the generic computing device 101 may correspond to a server in data integration system, as described in examples below. The generic computing device 101 may have a processor 103 for controlling overall operation of the server and its associated components, including random access memory (RAM) 105, read-only memory (ROM) 107, input/output (I/O) module 109, and memory 115.

I/O module 109 may include a microphone, mobile device, mouse, keypad, touch screen, scanner, optical reader, and/or stylus (or other input device(s)) through which a user of generic computing device 101 may provide input, and may also include one or more of a speaker for providing audio output and a video display device for providing textual, audiovisual, and/or graphical output. Software may be stored within memory 115 and/or other storage to provide instructions to processor 103 for enabling generic computing device 101 to perform various functions. For example, memory 115 may store software used by the generic computing device 101, such as an operating system 117, application programs 119, and an associated database 121. Alternatively, some or all of the computer executable instructions for generic computing device 101 may be embodied in hardware or firmware (not shown).

The generic computing device 101 may operate in a networked environment supporting connections to one or more remote computers, such as terminals 141 and 151. The terminals 141 and 151 may be personal computers or servers that include many or all of the elements described above with respect to the generic computing device 101. The network connections depicted in FIG. 1 include a local area network (LAN) 125 and a wide area network (WAN) 129, but may also include other networks. When used in a LAN networking environment, the generic computing device 101 may be connected to the LAN 125 through a network interface or adapter 123. When used in a WAN networking environment, the generic computing device 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Generic computing device 101 and/or terminals 141 or 151 may also be mobile terminals (e.g., mobile phones, smartphones, PDAs, notebooks, tablet computers, and the like) including various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

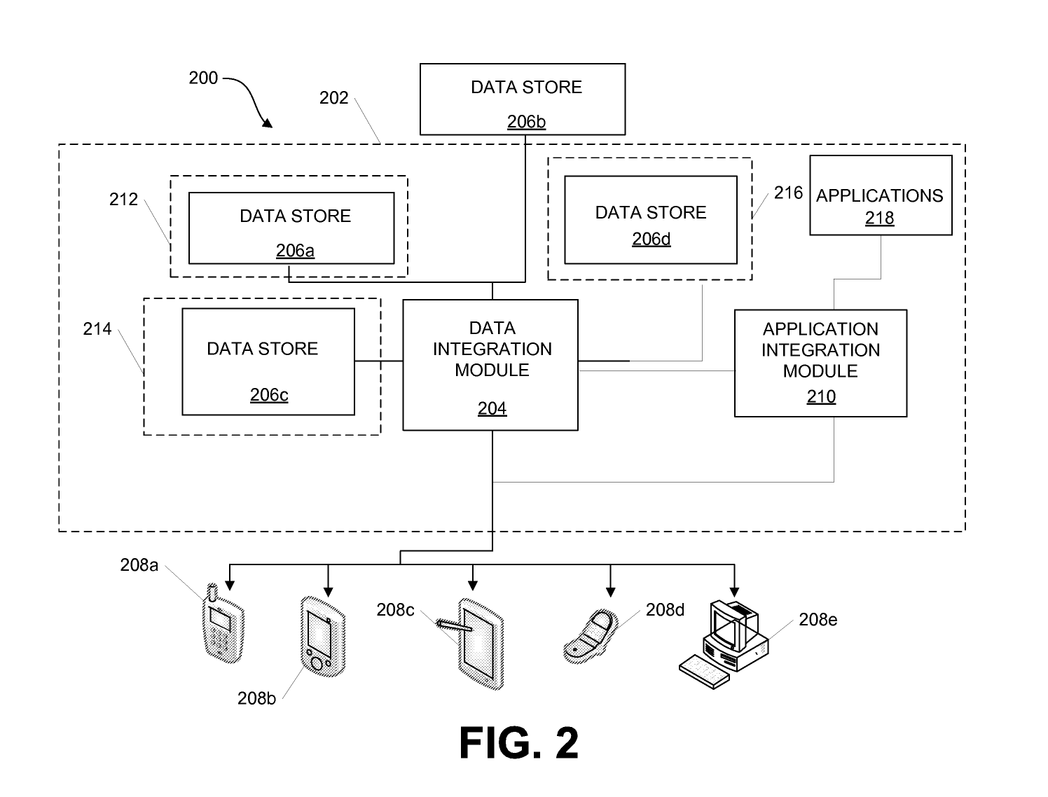

FIG. 2 illustrates one example data integration system 200 according to one or more aspects described herein. In some examples, the data integration system 200 may be part of, internal to or associated with an entity 202. The entity may be a corporation, university, government entity, and the like. In some examples, the entity 202 may be a financial institution, such as a bank. Although various aspects of the disclosure may be described in the context of a financial institution, nothing in the disclosure shall be construed as limiting the data integration system to use within a financial institution. Rather, the system may be implemented by various other types of entities without departing from the invention.

The data integration system 200 may include one or more data stores 206a-206d. The data stores 206a-206d may be internal to or associated with the entity 202, such as data stores 206a, 206c and 206d. In some examples, one or more of these internal data stores 206a, 206c, 206d may store information that is not publicly available. For instance, if the entity is a financial institution, one or more data stores may store information about the financials of a client (e.g., amount of debt held with financial institution, available funds, and the like). Additionally or alternatively, one or more data stores 206a-206d may be external to or not associated with the entity 202, such as data store 206b. The number of data stores provided in FIG. 2 is merely one example, and more or fewer data stores may be used with the data integration system without departing from the invention.

In some arrangements, the data stores 206a-206d store data associated with various aspects of the business of the entity 202. For instance, the data store 206a may store data associated with one of sales data, while data store 206c stores information associated with profitability data and data store 206d stores data associated with user performance or scorecard information. These examples of types of data stored in data stores 206a, 206c and 206d are merely some examples, other or additional types of data may also be stored in data stores 206a, 206c, and 206c and/or in additional data stores. For instance, data such as customer data, client contact information, client calling activity data, pending or completed business deal data, company financial information of the client, geographic information, underwriting information, fulfillment information, pricing information, servicing information, and the like may be stored in data stores 206a, 206c, 206d and/or other data stores.

In some examples, one or more of the data stores 206a, 206c, 206d may be associated with another system within the entity 202. For instance, to continue the example provided above, data store 206a may store sales data and may be a part of, internal to, or associated with, a sales system 212 of the entity 202. In some examples, the sales system may include some or all of the aspects of the general computing environment described with respect to FIG. 1. Thus, although the data store 206a may be a part of the sales system 212, the data may be transmitted to the data integration system 200 for use, as will be described more fully below.

Similarly, data store 206c may store profitability data and may be part of or associated with a profitability system 214, while data store 206d may store user performance data and may be associated with system 216 which may track user performance including one or more goals defined for each user, achievement toward the defined goals, and the like. Although data stores 206c and 206d may be associated with systems 214 and 216, respectively, the data stored therein may be transmitted to data integration system 200 for use. In some examples, the data integration system 200 may be separate from (e.g., physically separate from) the other systems storing the data, and data may be transmitted to the data integration system 200 via a network.

Although data stores 206a, 206c and 206d are shown in FIG. 2 as separate storage, one or more of the data stores may be part of or a portion of a larger data store.

Data integration system 200 may also include one or more data stores external to the entity 202. For instance, data store 206b may be a data store not associated with the entity 202 and may, in some examples, store data not associated with the entity 202. For instance, data store 206b may store public information as stored by a data warehouse or other type of entity. The public information may include news information such as current events, stock information about one or more companies, public information regarding various business deals or potential business deals of a company, and the like.

Data integration system 200 may further include a data integration module 204. In some examples, the data integration module 204 may be implemented in hardware and/or software configured to perform a set of specific functions within the data integration system. For example, the data integration module may include one or more data integration algorithms to receive data from one or more data stores 206a-206d and integrate the data in order to be displayed in a unified manner. For instance, data may be received by the data integration module 204 from various internal and external sources, including, in some examples, data stored by other systems associated with the entity 202, and may be combined such that it may be displayed to a user of the data integration system, such as via one or more of computing devices 208a-208e, as will be discussed more fully below.

Data integration system 200 may further include an application integration module 210. The application integration module 210 may be implemented in hardware and/or software configured to perform a specific set of functions within the data integration system 200. For instance, the application integration module 210 may include one or more algorithms to provide communication between one or more applications 212 or systems connected to the data integration system 200. For instance, the entity 202 may use, implement, run, and the like, various applications or apps, as indicated by 212. The applications may be associated with a plurality of different systems and may be part of a secured or non-secured environment. In some examples, the applications may be associated with the systems 212, 214, 216, with which the data stores 206a, 206c, 206d may be associated. The systems may include applications specific to the type of data associated with those systems (e.g., if a system tracks sales information, one or more applications used by sales associates may be associated with the system). Additionally or alternatively, the applications 212 may be those more universally used, such as email, calendar, task management, document management, contacts, annotation for taking, saving or emailing notes, map or location information, social media, voice to text, meeting and video collaboration tools, and the like. In some examples, one or more webpages may also be integrated by the application integration module 210. Accordingly, the application integration module 210 may integrate, or, in some examples, allow the applications, tools, and the like, to communicate with each other, regardless of whether they are in a secured or non-secured environment.

The application integration module 210 and data integration module 204 may be connected (e.g., such as via a network, and the like) to allow the integrated applications to communicate with each other and share data, such as the integrated data from the integrated data module 204. This integrated information and tools may be provided to a user, such as via a user interface, on a computing device 208. In some examples, the computing device may be a computing terminal, such as terminal 208e. In other examples, the computing device may be a module device, such as smartphone 208a, personal digital assistance (PDA) 208b, tablet computer 208c, cell phone 208d, notebook or laptop computer, and the like. The computing device 208 may permit a user to view, manipulate, transmit, and the like, data, such as the integrated data received from various sources or a portion thereof, to one or more other applications, such as the integrated applications from application integration module 210, in order to simplify their work and make it more efficient.

For instance, in an example in which the entity 202 is a financial institution, a banker (user) may have several clients. In order to efficiently and effectively provide banking or financial services to those clients, the banker may need to access information from variety of systems, such as sales information, marketing information, client contact information, geographic information, client calling and contact information, company financials, client pending deal information, pricing information client financial information, profitability information, information about pricing, underwriting, fulfillment, servicing, and the like. In today's on-the-go work environment, it may be cumbersome and inefficient to access this information from each system in which it is housed, even if performed remotely (e.g., from a tablet computing device). However, by providing data integration system 200, the banker may access the various types of information from a single source on his or her computing device (e.g., from a tablet computer). For instance, the banker may open an app and be provided with a user interface providing the various types of data, as described above. For example, if a banker is meeting with a client and is attempting to sell the client an additional product or service, it is advantageous for the banker to access not only client specific information (e.g., current products, contact information, and the like), but also to have access to data about underwriting (such as whether there is currently a credit review underway for the client), fulfillment (e.g., opening an account for the client as needed), servicing (e.g., is there an outstanding customer service issue or recently resolved customer service issue that may be a factor in making the sales call), and the like. Additional or other types of data may also be provided without departing from the invention. Providing this breadth of information in one integrated system that is easily accessible can provide information from an end-to-end perspective in, in some arrangements, a mobile work environment, to provide a strategic advantage in selling products.

In some examples, the user may be able to manipulate the user interface in order to provide different information, or present the information in a different way. For instance, a dashboard may appear for the user to view information. In some examples, the information may be displayed by metrics. For instance, a dashboard may provide 3 or more metrics for a user to view. Some examples of metrics may include profitability, number of products sold, types of products sold, total revenue, and the like. One or more portions of the dashboard may be removed and replaced with another metric. For instance, if the user dashboard illustrates metrics such as profitability, number of products sold and types of products sold, the user may desire to view information related to total revenue rather than number of products sold and may customize the dashboard to display the desired metrics.

In still other examples, a user may customize the presentation of the information. For example, information may default to being displayed in a pie chart format. A user may customize the display to display the information in another format, such as a bar graph, heat map, trend line, and the like. Additional details about customization may be described more fully below.

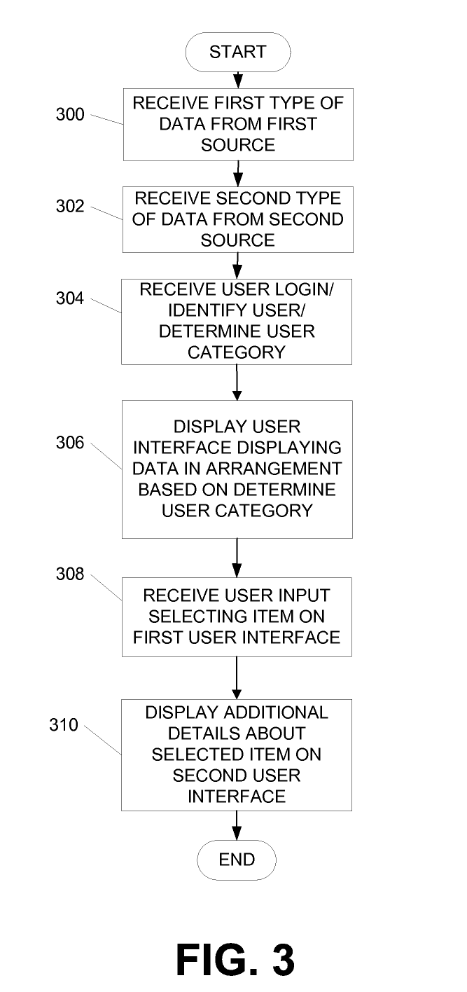

FIG. 3 illustrates one example method of providing information using the data integration system, such as system 200 in FIG. 2. In step 300, a first type of data may be received, such as by the data integration module, from a first source. For instance, a first type of data may include, for example, sales data, marketing data, customer data, or the like. In step 302, a second type of data from a second source may be received, such as by the data integration module, and integrated with the first type of data from the first source. In some examples, the first source may be integral to the entity implementing the system (similar to data stores 206a, 206c, or 206d in FIG. 2) and the second source may be external to the entity (similar to data store 206b).

In step 304, user login information is received by the system. The user login information may include a unique identifier, such as a username of the user, and a password. In some examples, biometric data may also be used in lieu of or in addition to a username and password to identify and/or authenticate the user.

With further reference to step 304, once the user is authenticated on the system, a user category may be determined for the user. For instance, the data integration system may identify one or more user categories for the various users of the system. In some examples, two user categories may be identified. For instance, there may be a first user category, which may include data arranged in a first arrangement to be accessible by a user, such as a banker or sales associate. The data may include clients associated with that user, as well as broader data, such as overall revenue, and the like. A second user category may be a supervisor category. In some examples, the supervisor category may display information associated with multiple users (e.g., multiple bankers) within that supervisor's organization. The data may also include data associated with the clients of the multiple users or bankers. On login, the system may identify the user as a banker or sales associate or supervisor and may display a dashboard or user interface particular to that category of user, as in step 306. The user may then customize the dashboard as desired. However, in some examples, some information may only be visible to a supervisor category user. For instance, one or more metrics may not be visible to a banker or sales associate but may be visible to a supervisor.

In some examples, either category of user may be able to alter the view of the user interface to provide information at a client level. For instance, a user may select a client level view and the information displayed may include information for one particular client (as selected by the user). In some arrangements, the information may include product information, contact information, sales information, comparisons between that client's purchases and other clients (for instance, other clients in a similar business field), client financial information, and the like.

In step 308, user selection of one or more items on the user interface may be received. Selection of one or more items may prompt a second user interface to display additional information about the selected item, as in step 310. In some examples, the second user interface may overlay the first user interface, or a portion thereof.

User selection of a portion of the second user interface may, in some examples, prompt a display of a third user interface showing additional details about the selected item. The third user interface may overlay the second user interface, or a portion thereof.

Additional user interfaces may be displayed upon selection of additional items, similar to the second and third user interfaces described above.

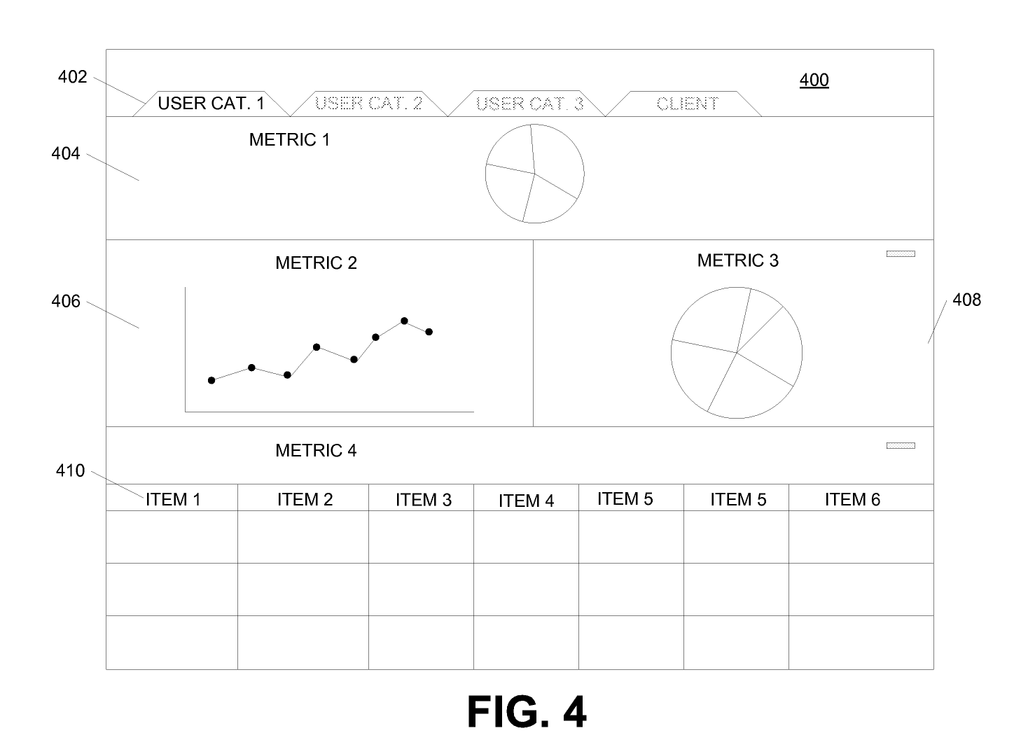

FIGS. 4-8 illustrate various example user interfaces that might be used to display the integrated data according to some aspects described herein. For instance, FIG. 4 illustrates one example user interface 400. The user interface 400 includes tabs identifying the user category of the user logged in. For instance, in FIG. 4, the user is identified as a category 1 user, as shown in tab 402. Various other user categories may also display integrated data. In some examples, there may be two, three, four or more user categories. Each user category may display integrated data arranged for the particular user category. That is, the data may be aggregated for display to a particular user category. In some examples, all integrated data may be available for viewing by any of the user categories, however, the initial dashboard display of each user category may present data that is directed to the particular user category.

With further reference to FIG. 4, the other user tabs are shown grayed out, but may not appear at all in some arrangements. The user interface 400 includes regions displaying metric 1 404, metric 2 406, metric 3 408 and metric 4 410. Although four metrics are shown, more of fewer metrics may be provided without departing from the invention.

The metrics shown may provide information about any of the possible metrics described above. For instance, the metrics may include sales information, revenue information, client specific information, product sales, profitability, sales associate performance, and the like. In some examples, the user may elect to display different metrics than the ones currently displayed. For instance, selection of, in some examples, the name of the metric, such as “metric 2” may prompt a drop down menu of other metrics that may be displayed in region 406 instead of metric 2. Although this is one example of changing the metrics provided on user interface 400, various other methods of customizing the metrics or data shown may be used without departing from the invention.

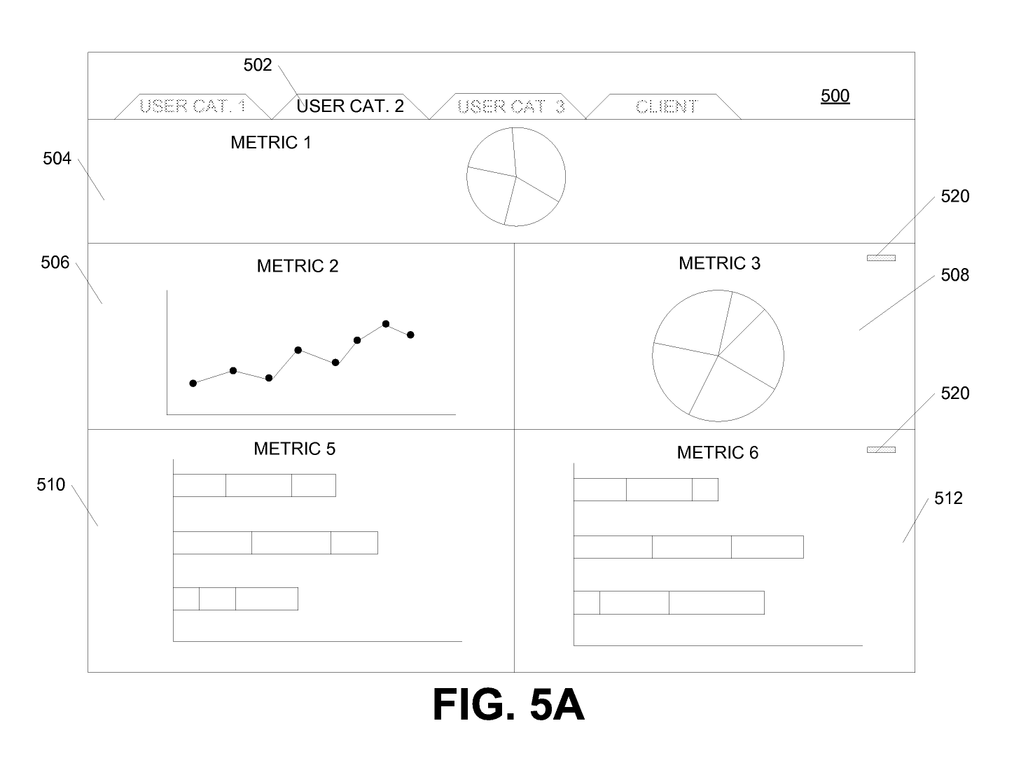

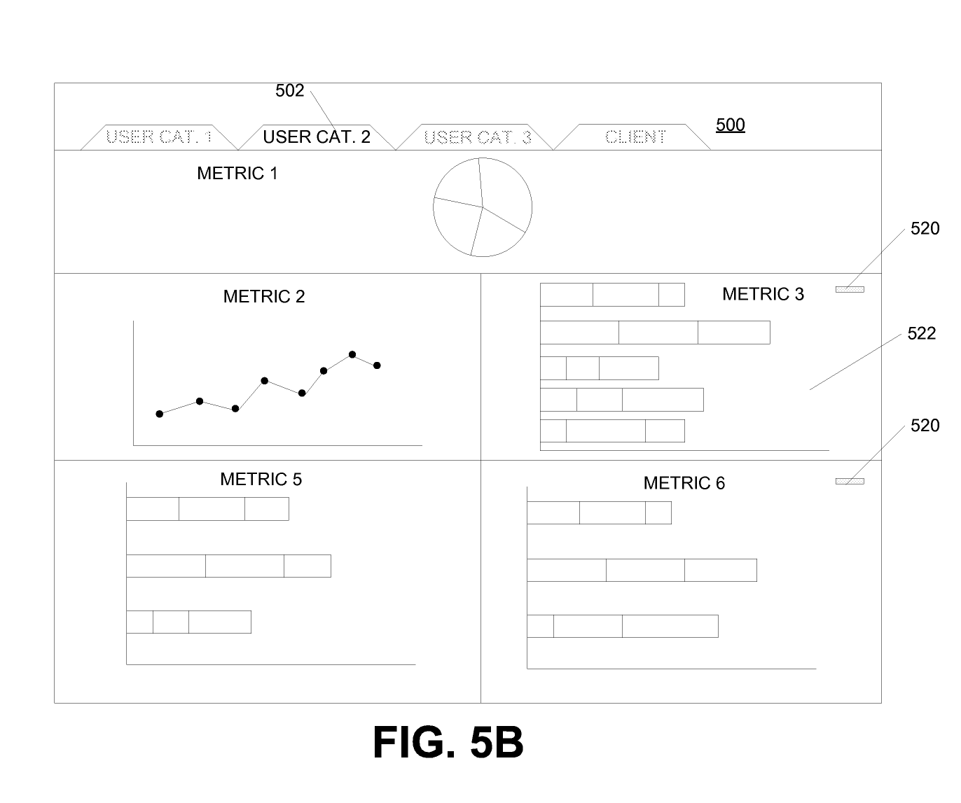

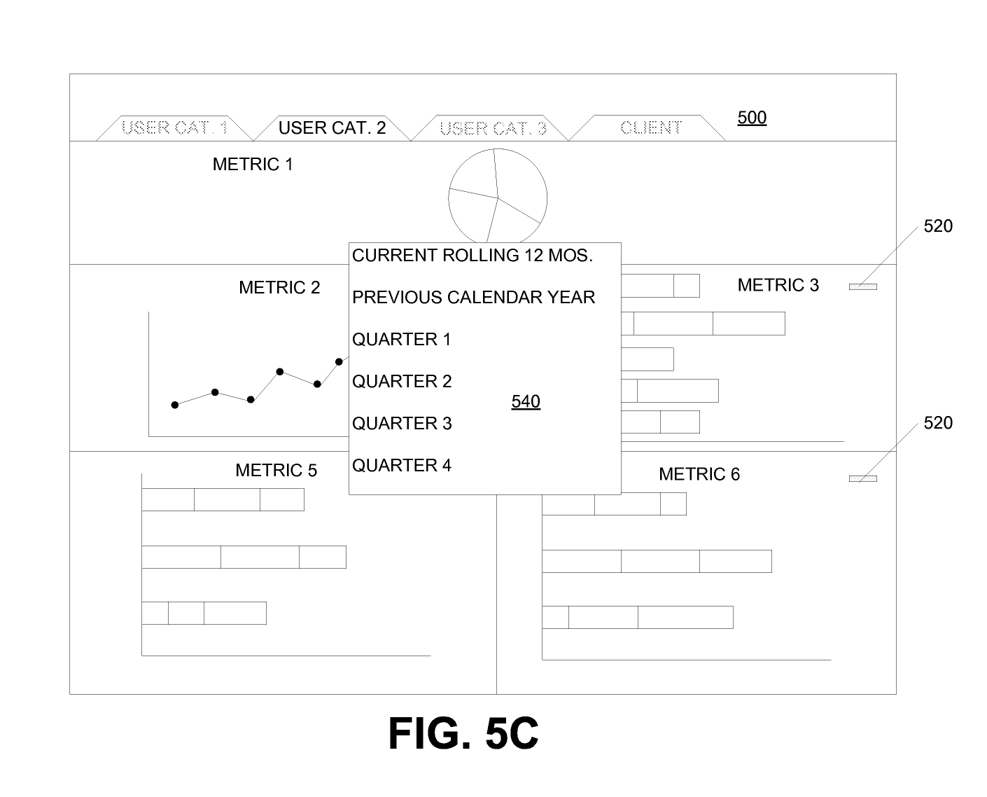

FIG. 5A illustrates another user interface 500. The user interface 500 identifies the user as a category 2 user in tab 502. For instance, the category 1 user in FIG. 4 may be a supervisor while the category 2 user may be a sales associate, banker, and the like. Accordingly, one or more of the metrics displayed in user interface 500 may be the same metrics as shown on the user interface 400 in FIG. 4. For instance, metric 1 504, metric 2 506 and metric 3 508 are all displayed on user interface 500. Additionally or alternatively, other metrics not displayed on interface 400 in FIG. 4 may be displayed on interface 500 in FIG. 5A. For example, metric 4 (410 in FIG. 4) is not shown on interface 500. However, metric 5 510 and metric 6 512 are shown on interface 500.

In some arrangements, presentation of the data within a region (e.g., presentation of the metric) may be customizable. For instance, although a default presentation of a metric may be a trend line, a user may prefer to see data in a bar graph, heat map, pie chart, and the like, form. Accordingly, in some examples, a user may select a customize icon, such as icon 520 in FIGS. 5A and 5B, to customize one or more regions of the interface 500.

FIG. 5B illustrates user interface 500 but metric 3 is shown in bar graph form in region 522 in FIG. 5B rather than in pie chart form in 508 in FIG. 5A. In some examples, selection of customize icon 520 may provide a drop down menu of display options for the metric in that region. This customization allows users to view data in a manner most convenient, efficient and accessible for the user. In some arrangements, each metric displayed may include a customization icon 520. In other examples, one icon may be used to customize the entire interface. In still other examples, a plurality of icons 520 may be provided to customize the regions available for customization.

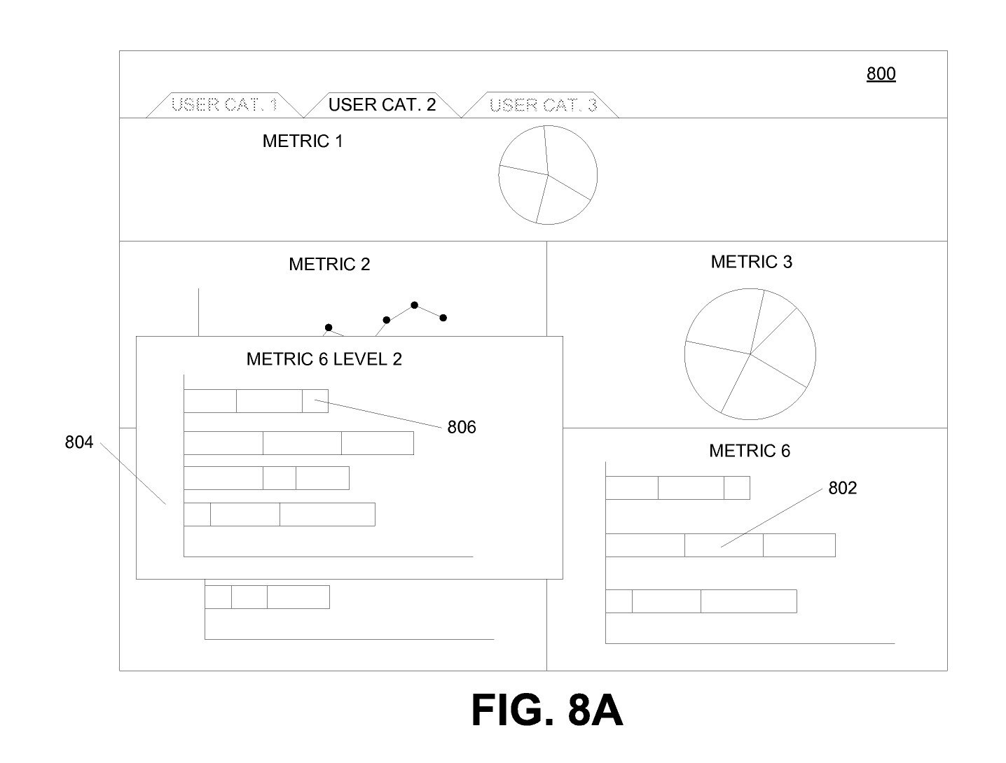

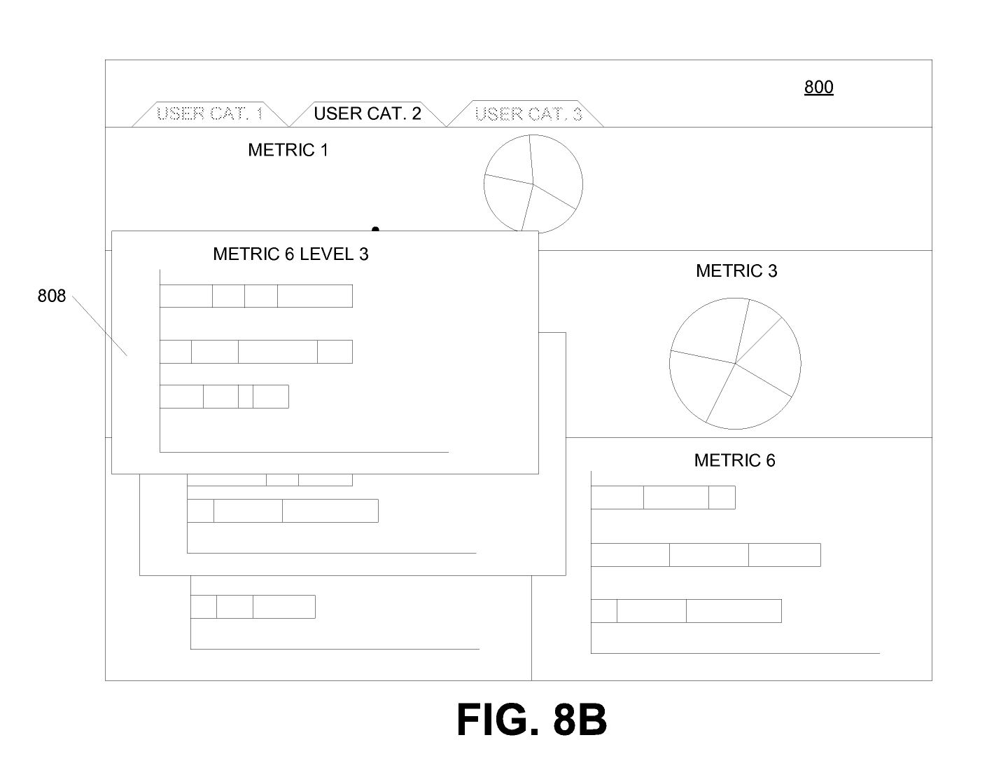

Additionally or alternatively, selection of icon 520 may also provide additional information about the metric. For example, selection of icon 520 may provide an opportunity to “drill down” into the metric to obtain additional information, more detailed information, and the like. Such drill-down arrangements are described more fully below with respect to FIGS. 8A and 8B.

In still other examples, selection of icon 520 may permit a user to compare one or more data items against each other and the comparison data may be displayed on a user interface (such as the interfaces described above). For instance, if a user desires to compare metric 3 for the current rolling 12 month period, as well as the previous calendar year, the user may select those two time period from, for instance, a drop down list, and the data associated with the desired time periods may be displayed.

FIG. 5C illustrates one example drop down menu 540 on user interface 500 in which multiple items for comparison may be displayed and selected. Upon selection of, for example, the icon 520, the drop down menu 540 may appear and a user may select one or more items to display for comparison. In some arrangements, a user may be able to select 2, 3, 4 or more items for comparison. Selection may be performed by clicking or double clicking on the desired item, by selection of a radio button, or the like. Further, an indication, such as a check mark, highlight, or other indication may appear next to selected items. Although the comparison options shown in FIG. 5C include time periods, various other items for selection may be provided without departing from the invention. For instance, comparison between multiple users or sales associates (e.g., revenue generated, profitability associated with associate, and the client), comparison between clients in a similar business field, comparison between number of products sold, comparison between multiple regions or organizations within an entity, and the like. In some examples, any metric and any type of data may be identified for comparison with another metric or type of data within the data integration system. The comparison may be displayed in a portion of the interface 500 (e.g., in portion 522) or in another interface overlaying a portion of interface 500, in a separate interface, and the like.

In some arrangements, the data displayed may also be filtered. For example, certain types of data may be displayed while others are not. In some examples, a comparison of multiple items may be selected but only a portion of the data may be displayed based on desired filters. For instance, a user may desired to view a comparison over revenue for an east, west, north and south regions. However, the user may only wish to see revenue generated by sales of one type of product. Accordingly, a user may apply a filter to exclude data associated with sales of all products except the desired type of product. Various other filter arrangements may be used without departing from the invention.

The arrangements described with respect to FIGS. 5A-5C (e.g., selection of icon 520 to view additional data, view comparison data, and the like) may be used with any of the various interfaces, arrangements, and the like described herein. Nothing in the description should be viewed as limiting these arrangements to only the interface 500 in FIGS. 5A-5C.

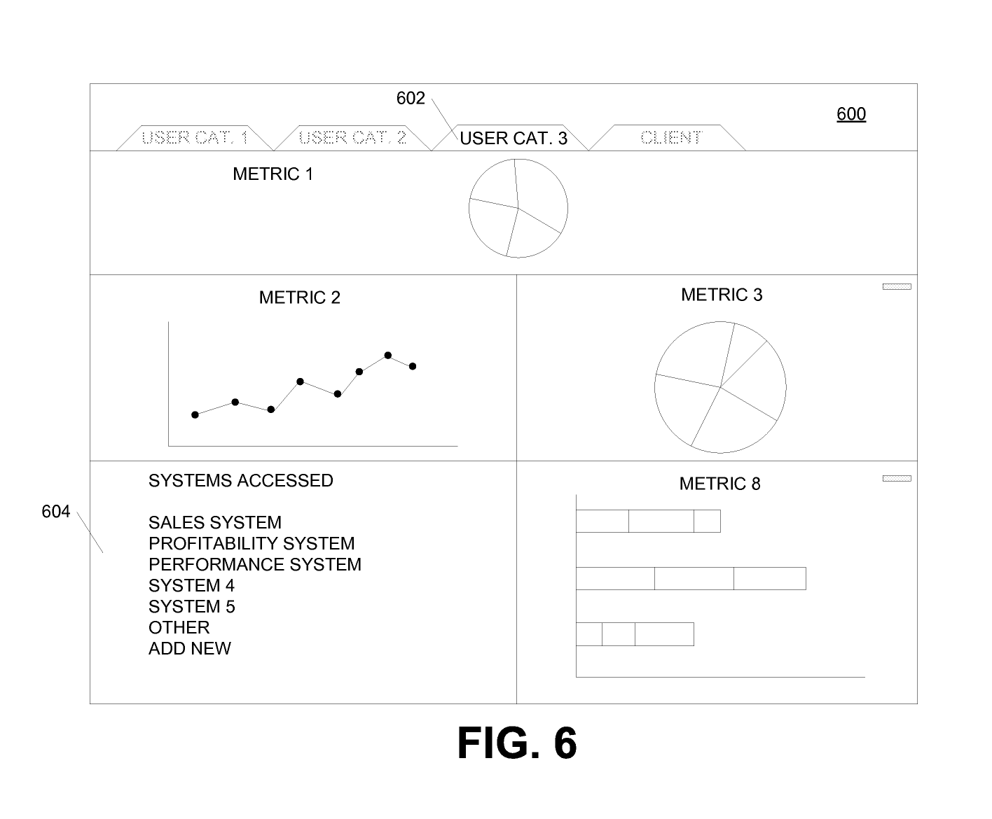

FIG. 6 illustrates yet another user interface 600. The interface 600 may be used for yet another identified user category, such as category 3 as shown in tab 602. In some examples, user category 3 may be associated with yet another type of user, such as a higher level supervisor, or an administrative associate. Alternatively, the user category 3 may be associated with an administrator who may, in some examples, have additional privileges when working with the data integration system. That is, the user in category 3 may view data and may also have authority to modify the data.

For example, in some arrangements, the data provided in the data integration system and associated user interfaces may be less than all of the available data. For example, because vast amounts of data may be stored in the various systems from which the data integration system receives data, a subset of the total data may be integrated and provided to users of the data integration system in order to simplify the data presentation and provide information that will be most useful to the users. In some examples, the contents of the subset of data may be determined by polling users to identify data or types of data that they use most often and including that data. In other examples, identifying the contents of the subset of data may be performed automatically by tracking the data or types of data most often accessed by users of the data integration system and providing that as the subset of data. In some arrangements, an administrator may control the contents of the subset of information provided and may, in some examples, have the capability and/or authorization to modify the subset as needed.

For example, a user may request to have additional data or an additional type of data included in the subset and thereby accessible via the data integration system. The administrator may then consider the usefulness of adding that information and may add it if it meets a certain criteria. In other examples, as new systems, apps, and the like are installed and used, the administrator may choose to add data from those systems, apps, and the like to the subset of data provided via the data integration system. For instance, the administrator may select the “add new” option from region 604 to add additional data or access to a system.

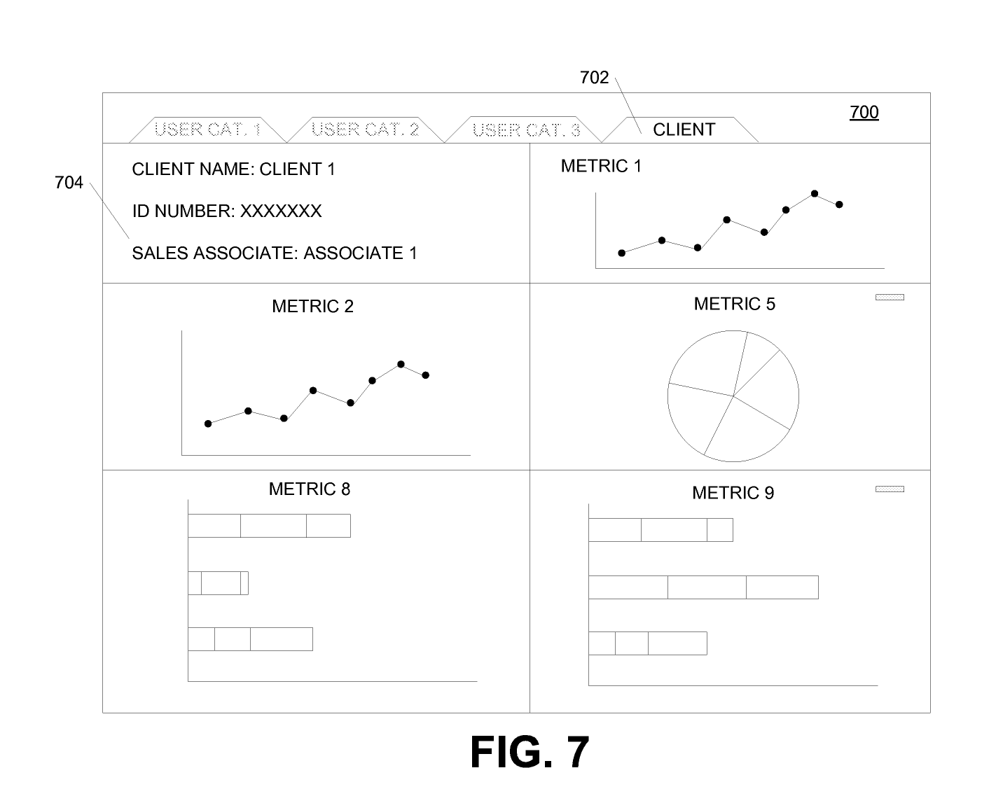

FIG. 7 illustrates another user interface 700 displaying client focused data. In some example, a user may desire to view information associated with a particular client, such as types of products purchased, most recent call or contact, contact information, client financial information, and the like. Accordingly, the user (which, in some examples, may be a user in any user category) may select a client view by selecting tab 702. Region 704 may display information about the client associated with the data displayed. In some examples, selection of the client name may prompt a user to insert a name of a client to view. In other examples, a list of available clients may be provided in a drop down menu and selection of a client may be performed by selecting a client from the list. In some examples, the client information provided may be data integrated by the data integration system and may include various types of data (e.g., sales, marketing, product, and the like) in one efficient system and interface.

FIGS. 8A and 8B illustrate examples of a user drilling down into data provided in order to obtain additional information about various data items. The user interface 800 displays a variety of metrics. If desired, a user may select an item (e.g., a metric, a piece of data, a portion of a graph, and the like) or may select an analytics icon (such as icon 520 in FIGS. 5A-5C) to obtain additional information about that item. In the example shown in FIGS. 8A and 8B, a user may desire to obtain additional information about portion 802 of metric 6. That portion may correspond to, in some examples, a client, a type of product sold, a period of time, and the like. Selection of portion 802 prompts display of a second user interface 804. The second user interface may include additional information about the selected portion 802. If additional information about a portion of the second user interface 804 is desired, a user may select the portion, such as portion 806, which may prompt display of another user interface 808 in FIG. 5B. Although two additional user interfaces 804 and 808 are provided, more or fewer user interfaces may be provided without departing from the invention. Further, the arrangement of the interfaces 804, 808 on interface 800 is merely one example arrangement. Various other positions, sizes, locations, configurations and the like may be used without departing from the invention.

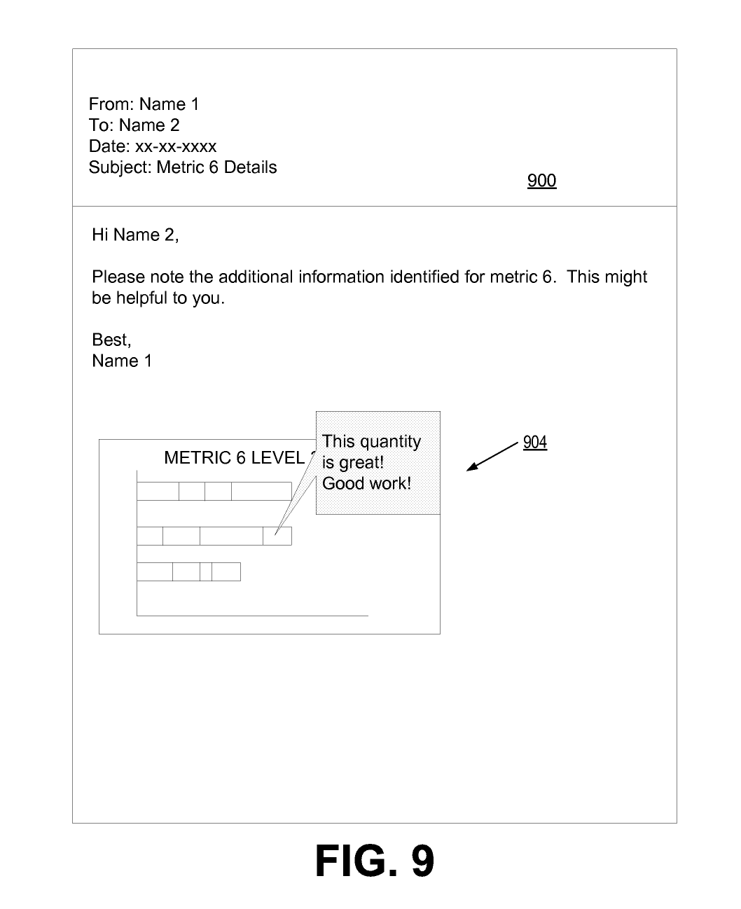

As discussed above, the data integration system integrates data and allows communication between various systems, applications and the like. For instance, data may be annotated and transmitted to other users. Further the data may be exported to other systems. In some examples, a user may desire to annotate a portion of the user interface and send it to a co-worker, such as via email. FIG. 9 illustrates one example of sharing data between applications. FIG. 9 illustrates an email message 900 that includes metric 6 from interface 800. The metric has been annotated to provide additional information to name 2, the recipient of the email message. The annotated portion of the interface 904 has been provided in the body of the email, along with the message from name 1, the sender, to name 2, the recipient. Various other sharing of data and communication, such as with task applications, calendar applications, document management systems, and the like, may be performed similarly.

In some arrangements, the annotated document (e.g., portion 904 or the email 900) may be saved in a library, such as a multimedia library. This document may then be accessed at a later time to view the annotation, compare the annotated document to current data, and the like. In some examples, the multimedia library may include a variety of documents, files, images, videos, and the like that may be used during, for instance a sales call. In some examples, the multimedia library may include digital brochures, web clips, videos, and the like, that may be downloaded to the user device and displayed during use of the integrated data system. In some examples, the content may be accessible in an offline mode (e.g., without an active network connection) such that a user does not require WiFi or other connectivity in order to access the content.

The data integration system may further include one or more alerts or triggers. For instance, a user may desire to be notified when a client of his has been identified in a news store, or when the financial information for the client within the entity has changed, when there is a change of contact person for the client, and the like. When a triggering event occurs, the user may receive a message, such as via email, SMS, MMS, via the data integration system dashboard, and the like, including the information. In some examples, this may be include high volumes of information. Accordingly, a user may identify particular types or categories of alerts to receive. In some examples, the alerts may include triggering events found in internal data (such as stored in data stores 206a, 206c, and 206d in FIG. 2) and/or external data (such as data store 206b). For instance, a user may desire to receive an alert if a client of his appears in a public news item about a pending business deal. Thus, various other public information about the client that may appear in the news might not generate an alert, but news about a pending business deal would. In another example, if the client financial information held by the entity changes, the user may desire to receive an alert. Various other types of alerts may be provided without departing from the invention.

In some examples, user performance metrics may be provided by the data integration system. The user performance metrics may include goals for each user (e.g., one or more goals for each associate or banker), progress toward the goal, sales numbers (e.g., number of products sold, and the like), incentives, and the like. The user performance metrics may be prepared, stored, determined, and the like by a separate performance tracking system. However, the data may be provided to the data integration system (e.g., on an interface or portion of an interface as described above) and may be visible to the user (e.g., the associate, banker, and the like) and to a manager or supervisor (e.g., user in another user category). In some examples, user performance data may be available for viewing by multiple users (e.g., multiple sales associates, bankers, and the like) so that each user can not only view his/her own progress, but also understand how other members of the team are performing. This may provide additional incentives to a user to meet or exceed the performance of other team members.

In still other examples, a supervisor may view performance information of all members of his team. For instance, the supervisor may be able to view his team's performance as a whole, the individual performance of one or more members of the team, and the like.

The data integration system described herein may provide a convenient, efficient way for users to view data integrated from multiple sources. In some examples, this may be beneficial for users who are often out of the office (e.g., visiting clients, and the like) as it may be used when online (e.g., connected to network, the Internet, and the like) or offline (e.g., without a network connection). Those users may implement the data integration system on a mobile device, such as a smartphone or tablet, and may access information in a simplified, streamlined manner, rather than attempting to access information by accessing a variety of different systems. The ability to customize, sort, and the like, the data may further allow users to work more efficiently.

Further, as discussed above, the data integration system, or one or more aspects thereof, may be used with a variety of types of devices (e.g., smartphone, cellphone, tablet computer, desktop computer, laptop, and the like). In some examples, portions of the data may be displayed on one particular device and not another. For example, one metric may be displayed on a tablet computing device but not on a smartphone of a user (e.g., to reserve space, provide proper viewing, and the like). Additionally or alternatively, the integrated data system may be used with devices from any manufacturer and does not require any particular operating system on the device in order to provide the functionality described herein.

In addition, the data integration system described herein may be integrated with various apps available via the Internet or other network connection to enhance functionality. For instance, the data integration system may include data from commonly used web location or mapping apps to provide directions, location information, and the like, to users. In other examples, the data integration system may be integrated with data from apps providing reviews or recommendations, services, and the like.

As discussed above, the data integration system may be integrated with a variety of systems within an entity. For instance, the data integration system may be protected by an entity firewall or other security systems. Further still, the data integration system may be integrated with one or more authentication systems and/or systems maintaining data, accessibility rules, and the like, to provide seamless access to the integrated data.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable medium. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

What is claimed is:

1. An apparatus, comprising:
at least one processor; and
memory storing computer-readable instructions that, when executed by the at least one processor, cause the apparatus to:
receive a first type of data from a first source;
receive a second type of data from a second source different from the first source;
integrate the first type of data with the second type of data;
receive login information and, based at least in part on the received login information, identify a user and determine a category of the user, the category of the user being one of a first user category or a second user category;
display a first user interface displaying the integrated data, wherein the first user interface displays the integrated data in an arrangement associated with the determined user category of the user, wherein at least one metric provided on the first user interface is common to the determined user category and the other user category and wherein at least one metric provided on the first user interface is unique to the determined user category; and
wherein selection of an item on the first user interface displays a second user interface providing additional data about the selected item.

2. The apparatus of claim 1, further including instructions that, when executed, cause the apparatus to:
receive user input selecting an alternate view of the integrated data, wherein the alternate view of the integrated data provides information about a particular client.

3. The apparatus of claim 1, further including receive user input to view the integrated data in an arrangement associated with another user category not associated with the user.

4. The apparatus of claim 1, wherein the first source is internal to an entity associated with the apparatus and the second source is external to the entity.

5. The apparatus of claim 4, wherein the entity is a financial institution.

6. The apparatus of claim 1, wherein the first type of data includes non-publicly available information and the second type of data includes publicly available information.

7. The apparatus of claim 1, wherein the first user interface and the second user interface are customizable.

8. The apparatus of claim 1, further including instructions that, when executed, cause the apparatus to:
receive a third type of data from a third source;
integrate the third type of data with the first type of data and the second type of data, wherein the third source is internal to an entity associated with the apparatus; and
display, on the first user interface, the integrated first, second and third types of data.

9. The apparatus of claim 1, wherein the first type of data is one of sales data, profitability data, underwriting data, fulfillment data, servicing data, and user performance data, and wherein the second type of data is publicly available marketing data.

10. The apparatus of claim 1, wherein the first data source is a secured environment and the second data source is a non-secured environment.

11. A method, comprising:
receiving, by a data integration system, a first type of data from a first source;
receiving, by the data integration system, a second type of data from a second source different from the first source;
integrating, by the data integration system, the first type of data with the second type of data;
receiving, by the data integration system, login information and, based at least in part on the received login information, identifying a user and determining a category of the user, the category of the user being one of a first user category or a second user category; and
displaying, by the data integration system, a user interface displaying the integrated data, wherein the user interface displays the integrated data in an arrangement associated with the determined user category of the user, wherein at least one metric provided on the first user interface is common to the determined user category and the other user category and wherein at least one metric provided on the first user interface is unique to the determined user category.

12. The method of claim 11, further including receiving, by the data integration system, user input selecting an alternate view of the integrated data, wherein the alternate view of the integrated data provides information about a particular client.

13. The method of claim 11, further including accessing at least one of a secure application and a non-secure application from the user interface.

14. The method of claim 11, wherein the first type of data includes non-publicly available information and the second type of data includes publicly available information.

15. The method of claim 11, further including:
receiving, by the data integration system, a third type of data from a third source;
integrating, by the data integration system, the third type of data with the first type of data and the second type of data, wherein the third source is internal to an entity associated with the data integration system; and
displaying, on the user interface, the integrated first, second and third types of data.

16. The method of claim 11, wherein the first type of data is one of sales data, profitability data, underwriting data, fulfillment data, servicing data, and user performance data, and wherein the second type of data is publicly available marketing data.

17. The method of claim 11, further including accessing the integrated data from at least one of a secure application and a non-secure application.

18. One or more non-transitory computer-readable media having computer-executable instructions stored thereon that, when executed, cause at least one computing device to:
receive, by the computing device, a first type of data from a first source;
receive, by the computing device, a second type of data from a second source different from the first source;
integrate, by the computing device, the first type of data with the second type of data;
receive, by the computing device, login information and, based at least in part on the received login information, identify a user and determine a category of the user, the category of the user being one of a first user category or a second user category; and
display, by the computing device, a first user interface displaying the integrated data, wherein the first user interface displays the integrated data in an arrangement associated with the determined user category of the user, wherein at least one metric provided on the first user interface is common to the determined user category and the other user category and wherein at least one metric provided on the first user interface is unique to the determined user category.

19. The one or more non-transitory computer readable media of claim 18, further including instructions that, when executed, cause the computing device to:
receive user input selecting an alternate view of the integrated data, wherein the alternate view of the integrated data provides information about a particular client.

20. The one or more non-transitory computer readable media of claim 18, wherein the first source is internal to an entity associated with the computing device and the second source is external to the entity.

21. The one or more non-transitory computer readable media of claim 20, wherein the first type of data includes non-publicly available information and the second type of data includes publicly available information.

22. The one or more non-transitory computer readable media of claim 18, further including instructions that, when executed, cause the computing device to:
receive, by the computing device, a third type of data from a third source;
integrate, by the computing device, the third type of data with the first type of data and the second type of data, wherein the third source is internal to an entity associated with the computing device; and
display, on the user interface, the integrated first, second and third types of data.

23. The one or more non-transitory computer readable media of claim 18, wherein the first type of data is one of sales data, profitability data, underwriting data, fulfillment data, servicing data, and user performance data, and wherein the second type of data is publicly available marketing data.

24. The one or more non-transitory computer readable media of claim 18, wherein the integrated data further includes a plurality of documents in a multi-media library.

25. The one or more non-transitory computer readable media of claim 18, further including instructions that, when executed, cause the computing device to:
receive user input identifying at least one type of alert to receive;
receiving an indication of a triggering event for the identified at least one type of alert; and
transmitting an alert to the user.
